(19) United States
(12) Patent Application Publication
(10) Pub. No.: US 2024/0213721 A1
(43) Pub. Date: Jun. 27, 2024

(54) METHOD FOR MANUFACTURING SHIELD SHELL AND CONNECTOR

(71) Applicant: YAZAKI CORPORATION, Tokyo (JP)

(72) Inventors: Tsuyoshi Hamai, Makinohara-shi (JP); Takatoshi Suzuki, Makinohara-shi (JP); Masakazu Nagaoka, Makinohara-shi (JP); Takuya Ohashi, Kakegawa-shi (JP)

(21) Appl. No.: 18/599,219

(22) Filed: Mar. 8, 2024

Related U.S. Application Data
(63) Continuation of application No. PCT/JP2022/044677, filed on Dec. 5, 2022.

(30) Foreign Application Priority Data
Dec. 28, 2021 (JP) 2021-214457

(51) Int. Cl. H01R 13/6581; B22D 17/00

(52) U.S. Cl. CPC H01R 13/6581; B22D 17/005

(57) ABSTRACT

Provided are a molding process of molding a shield shell with a mold provided with a first molding die and a second molding die, and a molded product extraction process of extracting the first molding die from the shield shell in a vertically providing direction of a peripheral wall body and extracting the second molding die from the shield shell in a second extraction direction orthogonal to a first extraction direction of the first molding die, in which, in the molding process, a first molding die that is a wall surface for forming a side wall surface with a draft angle relative to the first extraction direction and the second molding die that has a size enough to leave a gap between a screw hole and a male screw member and has a protrusion for forming the screw hole with the second extraction direction as a hole axis direction.

### CROSS-REFERENCE TO RELATED APPLICATION(S)

This application is a continuation application of International Application No. PCT/JP2022/044677 filed on Dec. 5, 2022 which claims the benefit of priority from Japanese Patent Application No. 2021-214457 filed on Dec. 28, 2021 and designating the U.S., the entire contents of which are incorporated herein by reference.

### BACKGROUND OF THE INVENTION

### 1. Field of the Invention

The present invention relates to a method for manufacturing a shield shell and a connector.

### 2. Description of the Related Art

Conventionally, in a vehicle, a plurality of electric devices having a shielding function such as suppressing entry of noise are mounted, and the shielding function of the electric devices is secured by electrically connecting the plurality of electric devices via a wire harness having the same shielding function. Therefore, the wire harness includes an electric wire, a shielding material such as a braid that covers the electric wire from the outside, and a connector that electrically connects the electric wire to an electric device. In the connector, a fitting portion of a housing is fitted and connected to a through hole of a metal chassis in an electric device, and an electric wire drawn into the housing is electrically connected to a device main body in the chassis. In addition, in this connector, the housing is surrounded by a metallic shield shell from the outside to suppress the intrusion of noise into the shield shell, and the shield shell is screwed and fixed to the chassis of the electric device to release the noise placed on the shielding material from the chassis to the vehicle body.

Specifically, the shield shell includes a main wall body that covers the housing from a side opposite to the fitting portion, and a peripheral wall body that is erected from a peripheral edge of the main wall body in a fitting connection direction of the fitting portion and covers the housing from a side. That is, in the shield shell, a space surrounded by the main wall body and the peripheral wall body serves as an accommodation chamber of the housing, and the accommodation chamber opens as an insertion port of the housing on the free end side of the peripheral wall body. Therefore, the shield shell covers the housing from the insertion port in the same direction as the fitting connection direction of the fitting portion. In the shield shell, a part of the wall portion of the peripheral wall body is used as a fixing wall portion for fixing to the attachment surface of the chassis. In the shield shell, at the fitting completion position of the fitting portion, the male screw member inserted into the screw hole of the fixing wall portion is screwed into the female screw portion of the chassis with the orthogonal axis with respect to the fitting connection direction as the screw shaft, and screwed and fixed to the attachment surface of the chassis. This type of connector is disclosed in, for example, Japanese Patent Application Laid-open No. 2018-163810 A and International Publication 2018/180480 A.

In the shield shell, in order to secure the axial force at the time of screwing and fixing, the fixing wall portion of the peripheral wall body is formed in a flat plate shape, and a screw hole having a hole axis orthogonal to the plane is formed in the fixing wall portion. However, since the shield shell adopts a shape like that described above, the first molding die after the formation of the accommodation chamber is removed in the same direction as the fitting connection direction. Therefore, in the first molding die, a side wall surface inclined with a draft angle with respect to the extracting direction is formed in order to facilitate extraction from the shield shell after molding. Therefore, the inner wall surface on the accommodation chamber side of the fixing wall portion in the peripheral wall body is formed as a plane inclined with respect to the fitting connection direction by the inclination of the draft angle. On the other hand, in the shield shell, the second molding die for forming the screw hole with the outer wall surface of the fixing wall portion is extracted from the shield shell in a direction orthogonal to the extracting direction of the first molding die. Therefore, in the fixing wall portion, the inner wall surface is inclined by the inclination of the draft angle with respect to the outer wall surface in the fitting connection direction. In the fixing wall portion, the outer wall surface is orthogonal to the hole axis of the screw hole, while the inner wall surface is inclined with respect to the hole axis of the screw hole by an inclination of the draft angle. In this case, when the fixing wall portion is screwed and fixed to the attachment surface of the chassis, the hole axis of the screw hole is inclined by the inclination of the draft angle with respect to the screw shaft of the female screw portion of the chassis. Therefore, there is a possibility that an appropriate axial force cannot be obtained, for example, if the male screw member is screwed to the female screw portion while caught on the peripheral edge of the screw hole. Therefore, in the conventional shield shell, the inner wall surface of the fixing wall portion is cut to be parallel to the outer wall surface, and the inner wall surface and the outer wall surface are orthogonal to the hole axis of the screw hole, thereby securing the axial force in screw fixing. As described above, in the conventional shield shell, the inner wall surface of the peripheral wall body is subjected to cutting work in order to secure the axial force, and this cutting work is a factor in an increase in cost.

### SUMMARY OF THE INVENTION

Therefore, an object of the present invention is to provide a method for manufacturing a shield shell and a connector capable of suppressing an increase in cost.

In order to achieve the above mentioned object, a method for manufacturing a shield shell according to one aspect of the present invention includes a molding process of molding a shield shell by press-fitting a molten metal into a mold provided with a first molding die that forms an accommodation chamber surrounded by a main wall body and a peripheral wall body and a second molding die that forms an outer wall surface of a fixing wall portion and a screw hole for inserting a male screw member in the fixing wall portion, the peripheral wall body being vertically provided from a peripheral edge of the main wall body and partially used as the fixing wall portion to be screwed and fixed to an attachment surface of an object to be fixed; and a molded product extraction process of extracting the shield shell having been molded from the mold, the molded product extraction process including extracting the first molding die from the shield shell in a vertically providing direction of the peripheral wall body and extracting the second molding die from the shield shell in a second extraction direction orthogonal to a first extraction direction of the first molding die, wherein, in the molding process, the first molding die that is a wall surface for forming an inner wall surface on the accommodation chamber side of the fixing wall portion and that has a side wall surface inclined with a draft angle with respect to the first extraction direction is used, the inner wall surface being brought into surface contact with the attachment surface after fixing with screws, and the second molding die has a protrusion for forming the screw hole is used, the screw hole having such a size that a gap is formed between the inner circumferential surface of the screw hole and the male screw member after screwing and fixing and having the second extraction direction as a hole axis direction.

In order to achieve the above mentioned object, a connector according to another aspect of the present invention includes a terminal fitting that electrically connects a physically and electrically connected electric wire to a device main body in a metal chassis of an electric device; a housing having a fitting portion to be fitted and connected to a through hole of the chassis, the housing accommodating the terminal fitting inward and drawing the electric wire outward; a metallic shield shell that has a housing accommodation chamber that covers the housing from the outside and accommodates the housing, and physically and electrically connects a shielding material that covers the electric wire from the outside; and a male screw member configured to screw and fix the shield shell to an attachment surface of the chassis with a screw shaft orthogonal to a fitting connection direction of the fitting portion, wherein the shield shell includes a main wall body that covers the housing from a side opposite to the fitting portion, and a peripheral wall body that is vertically provided from a peripheral edge of the main wall body in the fitting connection direction and covers the housing from a side, and uses a space surrounded by the main wall body and the peripheral wall body as the housing accommodation chamber, the peripheral wall body is used as a fixing wall portion for screwing and fixing a part of the peripheral wall body to the attachment surface, the fixing wall portion includes an inner wall surface on a housing accommodation chamber side that is brought into surface contact with the attachment surface after screwing and fixing, and a screw hole for male screw member insertion in which a direction orthogonal to the fitting connection direction is a hole axis direction, the inner wall surface of the fixing wall portion is a wall surface inclined with respect to the fitting connection direction, and is formed as an inclined surface closer to an outer wall surface side of the fixing wall portion in the fitting connection direction, the inclination of the inner wall surface of the fixing wall portion with respect to the fitting connection direction is an inclination of a draft angle of a molding die for forming a housing accommodation chamber extracted in the fitting connection direction after formation of the housing accommodation chamber, and the screw hole is formed in such a size that a gap is formed between an inner peripheral surface of the screw hole and the male screw member after screwing and fixing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is a partially enlarged view illustrating a cross section along line X-X in FIG. 1 together with a chassis of an electric device;

FIG. 3 is an exploded perspective view illustrating the connector of the embodiment with a shield shell removed;

FIG. 4 is a perspective view illustrating a first shield shell member;

FIG. 5 is a view illustrating a cross section along line X-X of FIG. 4 together with a mold;

FIG. 6 is a schematic cross-sectional view exaggeratedly illustrating a shield shell and a chassis of an electric device; and

FIG. 7 is an exploded perspective view of the housing.

### DETAILED DESCRIPTION OF THE PREFERRED EMBODIMENTS

Hereinafter, embodiments of a method for manufacturing a shield shell and a connector according to the present invention will be described in detail with reference to the drawings. Note that the present invention is not limited by the embodiment.

### Embodiment

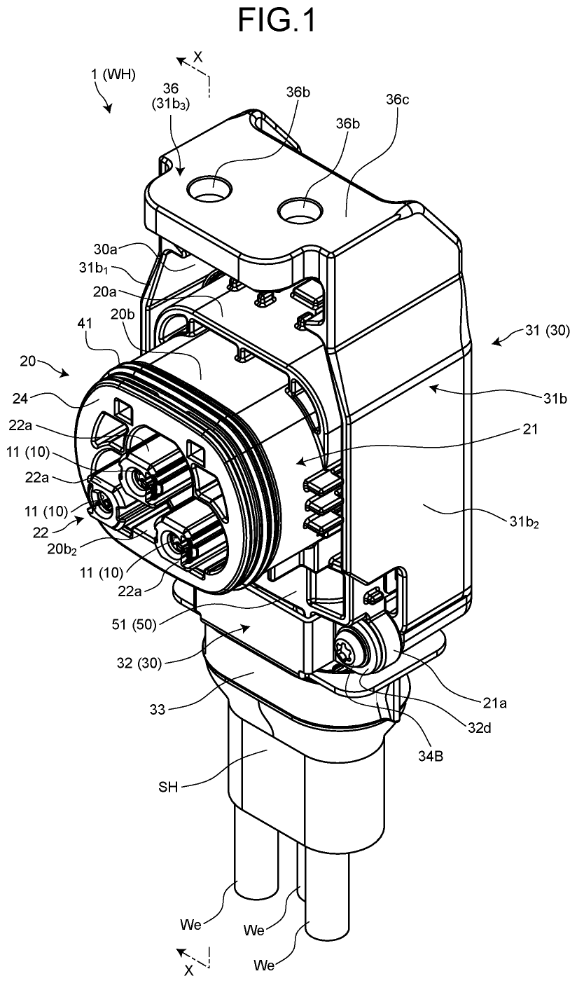

One embodiment of a method for manufacturing a shield shell and a connector according to the present invention will be described with reference to FIGS. 1 to 7.

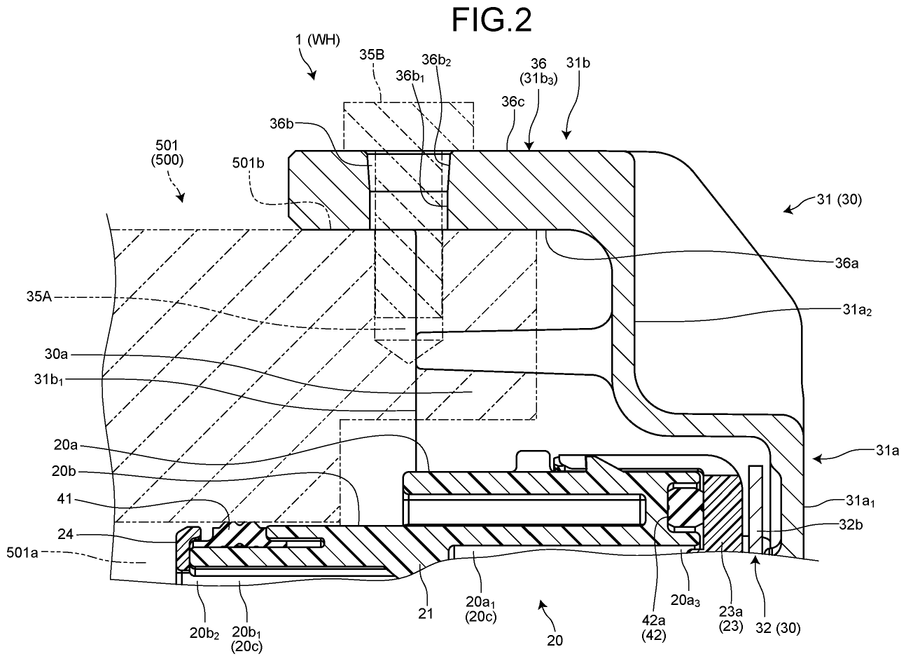

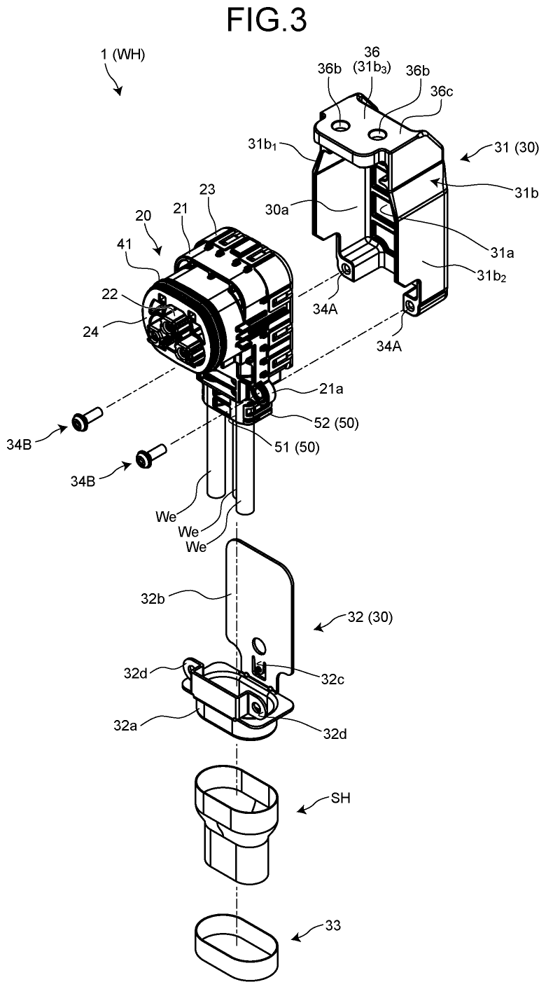

Reference numeral 1 in FIGS. 1 to 3 denotes a connector according to the present embodiment. The connector 1 is assembled to the end of an electric wire We, and constitutes a wire harness WH together with the electric wire We. The wire harness WH is disposed between a plurality of electric devices 500 (FIG. 2) mounted on a vehicle, and electrically connects the electric wire We to the electric device 500 via the connector 1, thereby electrically connecting the plurality of electric devices 500 via the electric wire We. Here, in order to secure the shielding function of the electric device 500, the wire harness WH also has the shielding function similarly to the electric device 500. Therefore, in the wire harness WH, a space between the plurality of connectors 1 in the electric wire We is covered with a shielding material SH (FIGS. 1 and 3) such as a tubular braid from the outside, and the connector 1 is configured as a so-called shield connector.

The connector 1 includes a terminal fitting 10 and an insulating housing 20 that houses the electric wire We and the terminal fitting 10 (FIG. 1). Further, the connector 1 includes a conductive shield shell 30 for reducing noise (FIGS. 1 to 6).

The terminal fitting 10 is formed of a conductive material such as a metal. For example, the terminal fitting 10 is formed into a predetermined shape by press molding such as bending or cutting a metal plate as a base material.

The terminal fitting 10 is physically and electrically connected to the terminal of the electric wire We. The terminal fitting 10 is electrically connected to a device main body (not illustrated) in a metal chassis 501 (FIG. 2) of an electric device 500.

The terminal fitting 10 includes a terminal connection portion 11 to be electrically connected to the device main body (FIG. 1). The terminal fitting 10 is indirectly electrically connected to the device main body by physically and electrically connecting the terminal connection portion 11 to a mating terminal fitting (not illustrated) of the electric device 500. The terminal connection portion 11 is physically and electrically connected to the mating terminal connection portion of the mating terminal fitting by being fitted and connected to the mating terminal connection portion along the fitting connection direction. In this example, the terminal connection portion 11 is formed in a cylindrical female terminal shape, and the mating terminal connection portion is formed in a shaft-like male terminal shape to be fitted into the terminal connection portion 11. A contact member (not illustrated) that is elastically deformed as the mating terminal connecting portion is inserted is assembled inside the terminal connection portion 11. Here, the mating terminal connection portion is fitted into the terminal connection portion 11, and a connection direction with respect to the mating terminal connection portion as viewed from the terminal connection portion 11 is defined as a fitting connection direction.

In addition, the terminal fitting 10 includes an electric wire connection portion (not illustrated) to be physically and electrically connected to the terminal of the electric wire We. The electric wire connection portion is physically and electrically connected to the electric wire We by, for example, crimping or welding the exposed core wire of the end of the electric wire We. The electric wire We is drawn out from the electric wire connection portion. In the terminal fitting 10, the terminal connection portion 11 and the electric wire connection portion are formed in order to pull out the electric wire We in a direction orthogonal to the fitting connection direction of the terminal connection portion 11.

The connector 1 includes a plurality of pairs of terminal fittings 10 and electric wires We. Here, three combinations are provided (FIG. 1). In the connector 1, the three terminal fittings 10 are arranged such that the fitting connection directions of all the terminal connection portions 11 coincide with the same direction, and the pull-out directions of all the electric wires We coincide with the same direction to cause all the electric wires We to run in parallel.

The housing 20 is formed of an insulating material such as a synthetic resin.

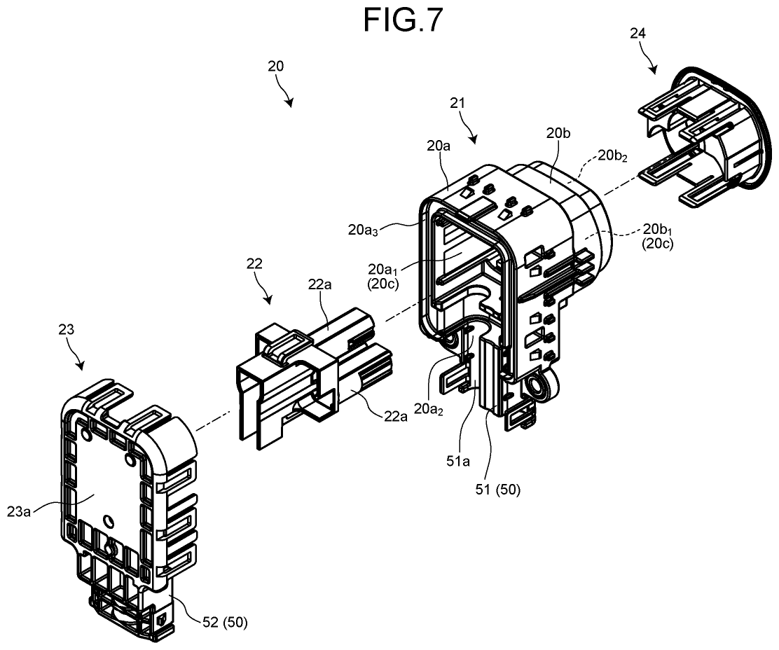

The housing 20 includes a first tubular portion 20a formed in a tubular shape, and a second tubular portion 20b having a tubular shape protruding from one end of the first tubular portion 20a in the tubular axis direction of the first tubular portion 20a such that the tubular axis direction of the second tubular portion 20b to be aligned with the tubular axis direction of the first tubular portion 20a (FIGS. 1, 2, and 7). In addition, the housing 20 has an accommodation chamber (hereinafter, it is referred to as a “terminal accommodation chamber”) 20c for accommodating the terminal fitting 10 therein (FIGS. 2 and 7). In the housing 20, a space 20a₁ inside the first tubular portion 20a and a space 20b₁ inside the second tubular portion 20b communicate with each other. In the housing 20, the respective inner spaces 20a₁ and 20b₁ are used as the terminal accommodation chamber 20c. Here, the electric wire connection portion is accommodated in the space 20a₁ inside the first tubular portion 20a, and the terminal connection portion 11 is accommodated in the space 20b₁ inside the second tubular portion 20b.

The terminal of the electric wire We is also accommodated in the space 20a₁ inside the first tubular portion 20a together with the electric wire connection portion. In the first tubular portion 20a, a notch 20a₂ for drawing out the electric wire We from the space 20a₁ is formed (FIG. 7). The first tubular portion 20a illustrated here is formed in a rectangular tubular shape, and a notch 20a₂ is provided on one side thereof.

In the space 20b₁ inside the second tubular portion 20b, the terminal connection portion 11 is accommodated with the fitting connection direction to the mating terminal connection portion aligned with the tubular axis direction. In the space 20b₁ inside the second tubular portion 20b illustrated here, the respective terminal connection portions 11 of the two terminal fittings 10 are accommodated side by side in a direction orthogonal to the tubular axis direction of the second tubular portion 20b (the fitting connection direction of the terminal connection portion 11) and the drawing direction of the electric wire We from the electric wire connection portion, and the terminal connection portion 11 of the remaining one terminal fitting 10 is accommodated at an interval in a direction opposite to the drawing direction of the electric wire We with respect to an intermediate position of the two terminal connection portions 11 (FIG. 1). That is, in the space 20b₁ inside the second tubular portion 20b, the terminal connection portions 11 of the three terminal fittings 10 are accommodated side by side at the apex positions of the triangles.

The housing 20 has a fitting portion to be fitted and connected to a through hole 501a (FIG. 2) of the chassis 501. In the housing 20, the second tubular portion 20b is used as the fitting portion (FIG. 1). The fitting portion (second tubular portion 20b) is inserted into and fitted into the through hole 501a of the chassis 501 along the fitting connection direction in the same direction as the fitting connection direction of the terminal connection portion 11 with respect to the mating terminal connection portion. The fitting portion (second tubular portion 20b) is removed from the through hole 501a of the chassis 501 along a removal direction opposite to the fitting connection direction. The fitting portion (second tubular portion 20b) is formed in a cylindrical shape in which an insertion and removal direction (insertion direction, insertion and removal direction) with respect to the through hole 501a is a cylinder axis direction. The fitting portion (second tubular portion 20b) illustrated here is formed in an elongated cylindrical shape whose cross section orthogonal to the insertion and removal direction is an elongated annular shape.

The connector 1 includes an annular seal member 41 that fills an annular gap between the outer peripheral surface of the fitting portion (second tubular portion 20b) and the inner peripheral surface of the through hole 501a in the chassis 501 to achieve waterproof and dust-proof therebetween (FIGS. 1 to 3). The seal member 41 is formed of an elastic member such as synthetic rubber. Then, the seal member 41 is assembled to the outer peripheral surface of the fitting portion (second tubular portion 20b).

The housing 20 of the present embodiment includes a housing main body 21 provided with a first tubular portion 20a and a second tubular portion 20b (FIGS. 1 to 3 and 7).

In the housing main body 21, the terminal fitting 10 is inserted into the terminal accommodation chamber 20c from an opening (an opening at an end opposite to the fitting connection direction) 20a₃ (FIGS. 2 and 7) at an end in the cylinder axis direction of the first tubular portion 20a. In the housing main body 21, the end portion of the terminal connection portion 11 on the engagement connection direction side protrudes from the opening (the opening of the end portion on the engagement connection direction side) 20b₂ (FIGS. 1, 2, and 7) of the end portion of the fitting portion (second tubular portion 20b) in the cylinder axis direction. The terminal fitting 10 is held in the terminal accommodation chamber 20c.

The housing 20 of the present embodiment includes a terminal holding member 22 which is accommodated in the terminal accommodation chamber 20c and holds the terminal fitting 10 in the terminal accommodation chamber 20c (FIGS. 1, 3, and 7). The terminal holding member 22 is formed of an insulating material such as synthetic resin. In the terminal holding member 22, a tubular terminal accommodation portion 22a that houses and holds the terminal connection portion 11 is provided for each terminal fitting 10 (FIGS. 1 and 7). The terminal holding member 22 is held by the housing main body 21 in the terminal accommodation chamber 20c. For example, although not described in detail, the housing main body 21 and the terminal holding member 22 are held between each other by a lock mechanism using a claw portion or the like that hooks each other.

In addition, the housing 20 of the present embodiment includes a holding portion (hereinafter, it is referred to as an “electric wire holding portion”) 50 that guides and holds the electric wire We pulled out from the notch 20a₂ of the first tubular portion 20a in the pull-out direction (FIGS. 1, 3, and 7). In the housing 20, the electric wire We is pulled out from the electric wire holding portion 50. The housing main body 21 includes a first holding portion 51 that serves as one end of the electric wire holding portion 50. In the first holding portion 51, a guide groove 51a for guiding the electric wire We in the pull-out direction is formed for each electric wire We (FIG. 7).

The housing 20 of the present embodiment includes a cover member 23 (FIGS. 2, 3, and 7) that closes an opening 20a₃ of the first tubular portion 20a, and a front holder 24 (FIGS. 1, 2, and 7) that is fitted into an opening 20b₂ of the fitting portion (second tubular portion 20b). The cover member 23 and the front holder 24 are formed of an insulating material such as synthetic resin.

The cover member 23 has a plate-like closing portion 23a that closes the opening 20a₃ of the first tubular portion 20a (FIGS. 2 and 7). The closing portion 23a is formed in a rectangular plate shape so as to close the rectangular opening 20a₃ of the first tubular portion 20a. The cover member 23 is held by the housing main body 21 at the assembly completion position. For example, although not described in detail, the housing main body 21 and the cover member 23 are held between each other by a lock mechanism using a claw portion or the like that hooks each other.

The connector 1 includes a seal member 42 that fills a gap between the first tubular portion 20a and the closing portion 23a to achieve waterproof and dust-proof therebetween (FIG. 2). The seal member 42 is formed of an elastic member such as synthetic rubber. The seal member 42 has a first seal portion 42a that is brought into close contact with the inner peripheral surface of the end portion of the first tubular portion 20a on the opening 20a₃ side and is brought into close contact with the wall surface of the outer peripheral edge of the closing portion 23a on the terminal accommodation chamber 20c side to achieve waterproofing and dustproofing in the opening 20a₃ of the first tubular portion 20a. Further, the seal member 42 has a second seal portion (not illustrated) that closes the notch 20a₂ of the first tubular portion 20a while inserting the electric wires We in close contact for each electric wire, and makes the notch 20a₂ waterproof and dustproof. The seal member 42 is assembled to the first tubular portion 20a together with the terminal fitting 10 attached to the end of the electric wire We.

Further, the cover member 23 includes a second holding portion 52 that serves as one end of the electric wire holding portion 50 together with the first holding portion 51 (FIGS. 3 and 7). In the second holding portion 52, a guide groove (not illustrated) for guiding the electric wire We in the pull-out direction is formed for each electric wire We. In the electric wire holding portion 50, when the assembly of the housing main body 21 and the cover member 23 is completed, a passage of the electric wire We is formed by the guide groove 51a of the first holding portion 51 and the guide groove of the second holding portion 52.

The front holder 24 is fitted into the opening 20b₂ of the fitting portion (second tubular portion 20b) while exposing the terminal accommodation portion 22a in which the terminal connection portion 11 is accommodated (FIG. 1). The front holder 24 is held by the housing main body 21 at the assembly completion position. For example, although not described in detail, the housing main body 21 and the front holder 24 are held between each other by a lock mechanism using a claw portion or the like that hooks each other.

The shield shell 30 is provided to suppress intrusion of noise into the housing 20 and to release noise carried on the shielding material SH from the chassis 501 of the electric device 500 to the vehicle body. Therefore, the shield shell 30 is formed of a conductive material such as metal. The shield shell 30 has an accommodation chamber (hereinafter, the housing accommodation chamber is referred to as a “housing accommodation chamber”) 30a that covers the housing 20 from the outside to house the housing 20 (FIGS. 1 to 6). Furthermore, the shield shell 30 is physically and electrically connected to the shielding material SH, and is physically and electrically connected to the chassis 501 as an object to be fixed.

The shield shell 30 includes a first shield shell member 31 and a second shield shell member 32 assembled to each other (FIGS. 1 to 3).

The housing accommodation chamber 30a is formed in the first shield shell member 31 (FIG. 3). The first shield shell member 31 includes a main wall body 31a that covers the housing 20 from the side opposite to the fitting portion (second tubular portion 20b), and a peripheral wall body 31b that is vertically provided from the peripheral edge of the main wall body 31a in the fitting connection direction of the fitting portion (second tubular portion 20b) and covers the housing 20 from the side (FIGS. 2 to 6). The first shield shell member 31 uses a space surrounded by the main wall body 31a and the peripheral wall body 31b as the housing accommodation chamber 30a.

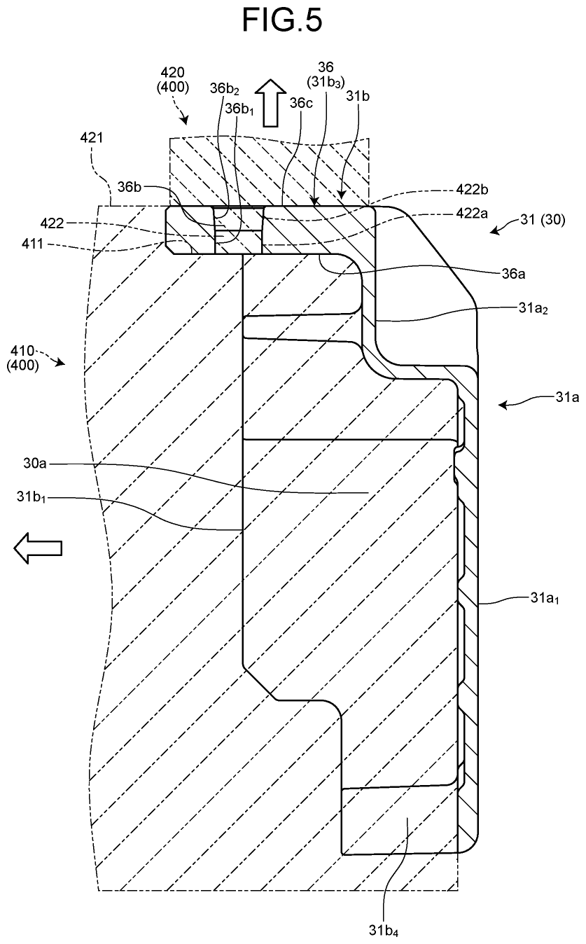

The main wall body 31a illustrated here includes a substantially rectangular and plate-shaped first main wall portion 31a₁ that covers the closing portion 23a of the cover member 23 from the outside, and a second main wall portion 31a₂ that is formed in an L-shaped plate shape and protrudes from an end portion of the first main wall portion 31a₁ on a side opposite to the pull-out direction side of the electric wire We toward the fitting connection direction of the fitting portion (second tubular portion 20b) (FIGS. 2 and 5).

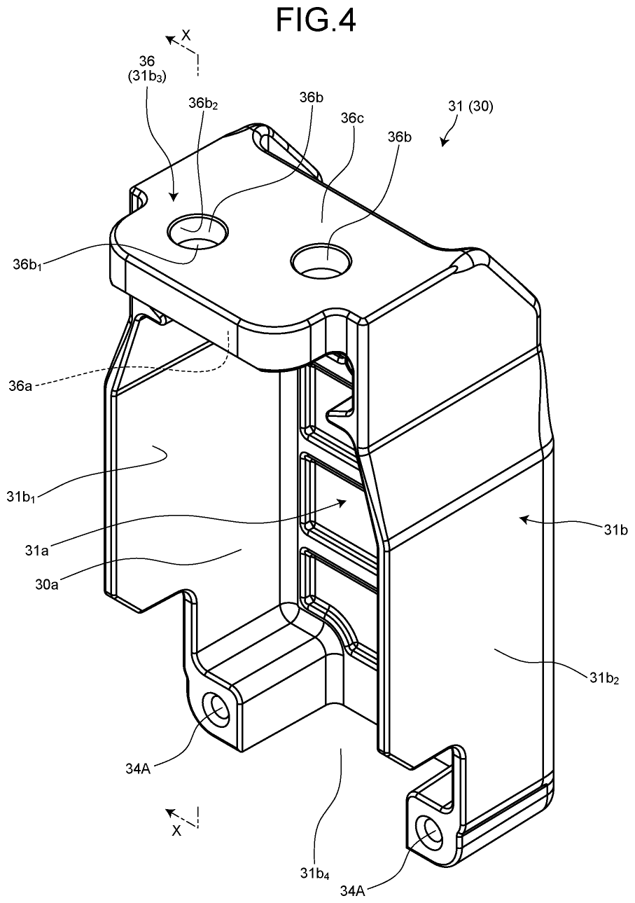

The peripheral wall body 31b shown here includes a plate-shaped first peripheral wall portion 31b₁ and a plate-shaped second peripheral wall portion 31b₂ which are vertically provided from respective end portions of the first main wall portion 31a₁ and the second main wall portion 31a₂ in a direction orthogonal to the fitting connection direction of the fitting portion (second tubular portion 20b) and the pull-out direction of the electric wire We, and a plate-shaped third peripheral wall portion 31b₃ which is provided vertically from an end portion of the second main wall portion 31a₂ on a side opposite to the pull-out direction side of the electric wire We (FIGS. 1, 3, and 4). On the other hand, in the peripheral wall body 31b shown here, the pull-out direction side of the electric wire We is notched, and the electric wire holding portion 50 of the housing 20 protrudes outward from a notch 31b₄ (FIGS. 4 and 5).

The second shield shell member 32 includes a tubular portion 32a having a tubular shape that surrounds the electric wire holding portion 50 protruding outward from the notch 31b₄ of the first shield shell member 31 from the outside, and a plate-like connection portion 32b interposed between the closing portion 23a of the cover member 23 and the first main wall portion 31a₁ of the first shield shell member 31 and physically and electrically connected to the first main wall portion 31a₁ (FIG. 3).

The tubular portion 32a surrounds the electric wire holding portion 50 with the drawing direction of the electric wire We as the cylindrical axis direction. The shielding material SH is physically and electrically connected to the outer peripheral surface of the tubular portion 32a by covering the outer peripheral surface of the tubular portion 32a with its end portion and further crimping an annular caulking member 33 covered from the outer side thereof (FIGS. 1 and 3).

The connection portion 32b has an elastic contact portion 32c that is elastically deformable (FIG. 3), and when the first shield shell member 31 and the second shield shell member 32 are at the assembly completion position, the elastic contact portion 32c is pressed against the wall surface of the first main wall portion 31a₁ by a resilient force.

In the shield shell 30, two female screw portions 34A in which the fitting connection direction of the fitting portion (second tubular portion 20b) is the screw shaft direction are formed in the first shield shell member 31, and the first shield shell member 31 and the second shield shell member 32 are screwed and fixed by screwing a male screw member 34B inserted into a through hole of each female screw portion 34A of a fixing portion 32d of the second shield shell member 32 into the female screw portion 34A (FIGS. 1 to 4). In the shield shell 30 illustrated here, a fixing portion 21a of the housing main body 21 is sandwiched between the fixing portion 32d and the female screw portion 34A, and the male screw member 34B inserted into the through hole of each of the fixing portions 32d and 21a is screwed into the female screw portion 34A to fasten and fix the housing main body 21 together (FIGS. 1 and 3).

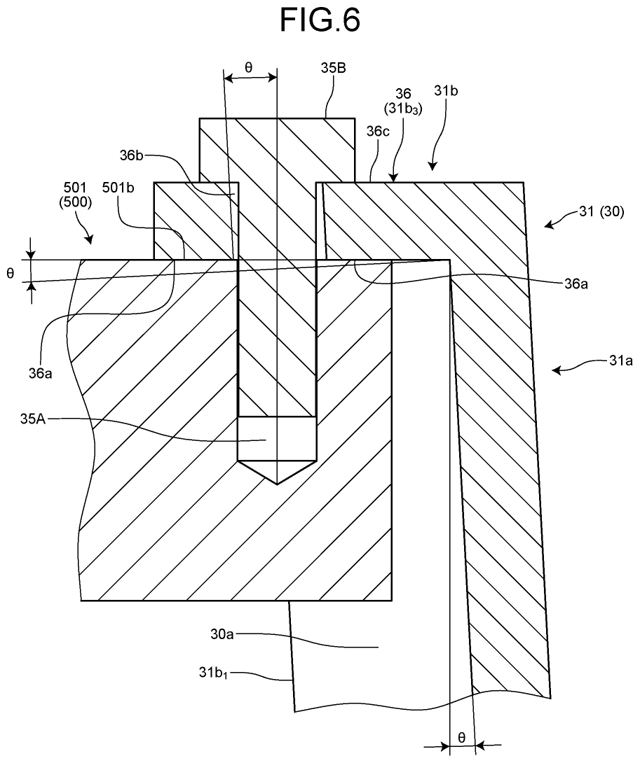

The shield shell 30 is physically and electrically connected to the chassis 501 by screwing and fixing the peripheral wall body 31b of the first shield shell member 31 to an attachment surface 501b of the chassis 501 of the electric device 500 (FIGS. 2 and 6). Two female screw portions 35A are formed on the attachment surface 501b of the chassis 501, and the peripheral wall body 31b is screwed and fixed with a screw shaft orthogonal to the fitting connection direction of the fitting portion (second tubular portion 20b). The connector 1 includes a male screw member 35B to be screwed to the female screw portion 35A with the screw shaft.

The peripheral wall body 31b is used as a fixing wall portion 36 for screwing and fixing a part thereof to the attachment surface 501b (FIGS. 1 to 6). In the peripheral wall body 31b, the fixing wall portion 36 is screwed and fixed to the attachment surface 501b with the direction orthogonal to the fitting connection direction of the fitting portion (second tubular portion 20b) as the screw shaft direction. In the fixing wall portion 36, an inner wall surface 36a on the housing accommodation chamber 30a side is brought into surface contact with the attachment surface 501b after being screwed and fixed (FIGS. 2 and 6).

In addition, the fixing wall portion 36 has a through hole (hereinafter, the hole is referred to as a “screw hole”) 36b for inserting a male screw member with a direction orthogonal to the fitting connection direction of the fitting portion (second tubular portion 20b) as a hole axis direction for each female screw portion 35A (FIGS. 1 to 5). In the peripheral wall body 31b shown here, the third peripheral wall portion 31b₃ is used as the fixing wall portion 36 (FIGS. 1 to 6). Therefore, the fixing wall portion 36 is screwed and fixed to the attachment surface 501b with the drawing direction of the electric wire We as the screw shaft direction. Therefore, the fixing wall portion 36 is formed with a screw hole 36b in which the drawing direction of the electric wire We is the hole axis direction in the direction orthogonal to the fitting connection direction of the fitting portion (second tubular portion 20b).

Meanwhile, in the shield shell 30, the first shield shell member 31 is die-cast using, for example, aluminum or an aluminum alloy by using a mold 400 for die-cast molding (FIG. 5). That is, the first shield shell member 31 is molded by press-fitting molten metal such as aluminum into the mold 400 and solidifying the molten metal. The method for manufacturing the shield shell 30 includes a molding process of the first shield shell member 31 using such the mold 400.

The mold 400 is provided with a first molding die 410 for forming a housing accommodation chamber forming the housing accommodation chamber 30a (FIGS. 1 to 6) of the first shield shell member 31, and a second molding die 420 forming an outer wall surface 36c (FIGS. 1 to 6) of the fixing wall portion 36 in the first shield shell member 31 and the screw hole 36b (FIGS. 1 to 6) of the fixing wall portion 36 (FIG. 5). In the molding process, the first molding die 410 and the second molding die 420 are used.

The method for manufacturing the shield shell 30 includes a molded product extraction process, which is a process of taking out the first shield shell member 31 having been molded from the mold 400, that is, of extracting the first molding die 410 from the first shield shell member 31 in a vertically providing direction (that is, the fitting connection direction of the fitting portion (second tubular portion 20b)) of the peripheral wall body 31b and extracting the second molding die 420 from the first shield shell member 31 in a second extraction direction orthogonal to the first extraction direction of the first molding die 410. The first molding die 410 has a side wall surface 411 that is a wall surface for forming the inner wall surface 36a of the fixing wall portion 36 on the side of the housing accommodation chamber 30a, and has a draft inclined with a draft angle θ (FIG. 6) with respect to the first extraction direction (FIG. 5). Therefore, the inner wall surface 36a of the fixing wall portion 36 is a wall surface inclined with respect to the fitting connection direction of the fitting portion (second tubular portion 20b), and is formed as an inclined surface closer to the outer wall surface 36c of the fixing wall portion 36 in the fitting connection direction. The inclination of the inner wall surface 36a of the fixing wall portion 36 with respect to the fitting connection direction is the inclination of the draft angle θ of the first molding die 410.

The second molding die 420 includes a wall surface 421 for forming the outer wall surface 36c of the fixing wall portion 36 and a protrusion 422 for forming the screw hole 36b of the fixing wall portion 36 (FIG. 5). The protrusion 422 protrudes from the wall surface 421, and forms the screw hole 36b having a size with which a gap is formed between the inner peripheral surface of the screw hole 36b and the male screw member 35B after screwing and fixing and having the second extraction direction as the hole axis direction.

For example, the inner peripheral surface of the screw hole 36b is formed in the following shape. The inner peripheral surface of the screw hole 36b shown here includes a first inner peripheral portion 36b₁ formed as an inclined surface of a first truncated cone whose hole diameter increases toward the fitting connection direction of the fitting portion (second tubular portion 20b) on the inner wall surface 36a side of the fixing wall portion 36, and a second inner peripheral portion 36b₂ formed as an inclined surface of a second truncated cone whose hole diameter increases toward the fitting connection direction of the fitting portion (second tubular portion 20b) on the outer wall surface 36c side of the fixing wall portion 36 (FIGS. 2, 4, and 5). The second inner peripheral portion 36b₂ is formed to have a larger hole diameter than the first inner peripheral portion 36b₁ and to have an inclination angle with respect to the fitting connection direction of the fitting portion (second tubular portion 20b) larger than the first inner peripheral portion 36b₁.

Specifically, in the second molding die 420, the inner peripheral surface of the screw hole 36b is formed by the protrusion 422 having the following outer peripheral surface. The outer peripheral surface of the protrusion 422 has a first outer peripheral portion 422a that is a wall surface for forming the inner wall surface 36a side of the fixing wall portion 36 on the inner peripheral surface of the screw hole 36b and is tilted with a first draft angle with respect to the second extraction direction over the circumferential direction, and a second outer peripheral portion 422b that is a wall surface for forming the outer wall surface 36c side of the fixing wall portion 36 on the inner peripheral surface of the screw hole 36b and is tilted with a second draft slope that is larger in slope than the first draft slope with respect to the second extraction direction over the circumferential direction (FIG. 5). On the outer peripheral surface of the protrusion 422, the first outer peripheral portion 422a forms the first inner peripheral portion 36b₁ of the screw hole 36b, and the second outer peripheral portion 422b forms the second inner peripheral portion 36b₂ of the screw hole 36b.

After the first shield shell member 31 is screwed and fixed to the attachment surface 501b of the chassis 501, the inner wall surface 36a of the fixing wall portion 36 comes into surface contact with the attachment surface 501b, and thus, the first shield shell member 31 is inclined with respect to the chassis 501 by an inclination of the draft angle θ of the first molding die 410 (FIG. 6).

In the connector 1, the entire first shield shell member 31 is inclined with respect to the chassis 501 by an inclination amount, but the inclination is absorbed by, for example, elastic deformation of the seal member 41. In the first shield shell member 31, the hole axis of the screw hole 36b of the fixing wall portion 36 is inclined by the inclination of the draft angle θ of the first molding die 410 due to the inclination with respect to the chassis 501 (FIG. 6). However, the screw hole 36b is formed in such a size that a gap is formed between the inner peripheral surface of the screw hole and the male screw member 35B after screwing and fixing. Therefore, the male screw member 35B can be screwed to the female screw portion 35A without being caught by the peripheral edge of the screw hole 36b. Therefore, the first shield shell member 31 can generate an axial force as designed between the female screw portion 35A and the male screw member 35B even while leaving an inclination corresponding to the inclination of the draft angle θ of the first molding die 410 on the inner wall surface 36a of the fixing wall portion 36. As described above, in the manufacturing method of the shield shell 30 and the connector 1 of the present embodiment, cutting for removing the inclination associated with the draft angle θ of the first molding die 410 with respect to the inner wall surface 36a of the fixing wall portion 36 as in the related art is not required in a post-process after the molding process, and thus, it is possible to suppress an increase in cost. In addition, since the manufacturing method of the shield shell 30 and the connector 1 of the present embodiment do not apply an unnecessary load between the male screw member 35B and the peripheral edge of the screw hole 36b and between the female screw portion 35A and the male screw member 35B, durability can be improved.

Here, in the fixing wall portion 36 described so far, the inner wall surface 36a is inclined with respect to the fitting connection direction of the fitting portion (second tubular portion 20b), while the outer wall surface 36c is not inclined. Therefore, in the current fixing wall portion 36, it may be difficult to secure the bearing surface of the male screw member 35B depending on the plate thickness thereof and the magnitude of the draft angle θ of the first molding die 410. Therefore, the wall surface 421 of the second molding die 420 is an inclined wall surface for forming the outer wall surface 36c of the fixing wall portion 36 as a wall surface parallel to the inner wall surface 36a of the fixing wall portion 36. Due to this inclined wall surface 421, the outer wall surface 36c of the fixing wall portion 36 is formed as a wall surface parallel to the inner wall surface 36a of the fixing wall portion 36 in the molding process (FIG. 6). Therefore, since the fixing wall portion 36 can secure the bearing surface of the male screw member 35B regardless of the plate thickness thereof and the magnitude of the draft angle θ of the first molding die 410, it is easy to generate the designed axial force between the female screw portion 35A and the male screw member 35B. As described above, in the manufacturing method of the shield shell 30 and the connector 1 of the present embodiment, the inclination of the outer wall surface 36c of the fixing wall portion 36 is simultaneously formed in the molding process, and thus, it is possible to suppress the cost increase also from this point. In addition, in the manufacturing method of the shield shell 30 and the connector 1 of the present embodiment, since the axial force as designed is likely to be generated, it is possible to suppress the screw loosening and improve the durability such as suppressing the plastic deformation of the bearing surface on the outer wall surface 36c of the fixing wall portion 36.

In the connector including the shield shell molded by the method for manufacturing a shield shell according to the present embodiment, the shield shell is inclined with respect to the object to be fixed (chassis) by the inclination of the draft angle of the first molding die (molding die for forming the housing accommodation chamber) since the inner wall surface of the fixing wall portion comes into surface contact with the attachment surface after being screwed and fixed to the attachment surface of the object to be fixed (chassis). In the shield shell, the hole axis of the screw hole of the fixing wall portion is inclined by the inclination of the draft angle of the first molding die (molding die for forming the housing accommodation chamber) due to the inclination with respect to the object to be fixed (chassis). However, the screw hole is formed in such a size that a gap is formed between the inner peripheral surface of the screw hole and the male screw member after screwing and fixing. Therefore, the male screw member can be screwed to the female screw portion without being hooked on the peripheral edge of the screw hole. Therefore, the shield shell can generate an axial force as designed between the female screw portion and the male screw member even while leaving an inclination corresponding to the inclination of the draft angle of the first molding die (molding die for forming the housing accommodation chamber) on the inner wall surface of the fixing wall portion. As described above, in the method for manufacturing a shield shell and the connector according to the present embodiment, cutting work for removing the inclination associated with the draft angle of the first molding die (molding die for forming the housing accommodation chamber) as in the related art with respect to the inner wall surface of the fixing wall portion is not required in a post-process after the molding process, and thus it is possible to suppress an increase in cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for manufacturing a shield shell comprising:
a molding process of molding a shield shell by press-fitting a molten metal into a mold provided with a first molding die that forms an accommodation chamber surrounded by a main wall body and a peripheral wall body and a second molding die that forms an outer wall surface of a fixing wall portion and a screw hole for inserting a male screw member in the fixing wall portion, the peripheral wall body being vertically provided from a peripheral edge of the main wall body and partially used as the fixing wall portion to be screwed and fixed to an attachment surface of an object to be fixed; and
a molded product extraction process of extracting the shield shell having been molded from the mold, the molded product extraction process including extracting the first molding die from the shield shell in a vertically providing direction of the peripheral wall body and extracting the second molding die from the shield shell in a second extraction direction orthogonal to a first extraction direction of the first molding die, wherein,
in the molding process, the first molding die that is a wall surface for forming an inner wall surface on the accommodation chamber side of the fixing wall portion and that has a side wall surface inclined with a draft angle with respect to the first extraction direction is used, the inner wall surface being brought into surface contact with the attachment surface after fixing with screws, and the second molding die has a protrusion for forming the screw hole is used, the screw hole having such a size that a gap is formed between the inner circumferential surface of the screw hole and the male screw member after screwing and fixing and having the second extraction direction as a hole axis direction.

2. The method for manufacturing a shield shell according to claim 1, wherein, in the molding process, the second molding die provided with an inclined wall surface for forming the outer wall surface of the fixing wall portion as a wall surface parallel to the inner wall surface of the fixing wall portion is used.

3. The method for manufacturing a shield shell according to claim 1, wherein, in the molding process, the inner peripheral surface of the screw hole is formed by the protrusion having, on the outer peripheral surface, a first outer peripheral portion that is a wall surface for forming the inner wall surface side of the fixing wall portion in the inner peripheral surface of the screw hole and is inclined with a first draft angle with respect to the second extracting direction over the circumferential direction, and a second outer peripheral portion that is a wall surface for forming the outer wall surface side of the fixing wall portion in the inner peripheral surface of the screw hole and is inclined with a second draft angle larger than the first draft angle with respect to the second extracting direction over the circumferential direction.

4. The method for manufacturing a shield shell according to claim 2, wherein, in the molding process, the inner peripheral surface of the screw hole is formed by the protrusion having, on the outer peripheral surface, a first outer peripheral portion that is a wall surface for forming the inner wall surface side of the fixing wall portion in the inner peripheral surface of the screw hole and is inclined with a first draft angle with respect to the second extracting direction over the circumferential direction, and a second outer peripheral portion that is a wall surface for forming the outer wall surface side of the fixing wall portion in the inner peripheral surface of the screw hole and is inclined with a second draft angle larger than the first draft angle with respect to the second extracting direction over the circumferential direction.

5. A connector comprising:
a terminal fitting that electrically connects a physically and electrically connected electric wire to a device main body in a metal chassis of an electric device;
a housing having a fitting portion to be fitted and connected to a through hole of the chassis, the housing accommodating the terminal fitting inward and drawing the electric wire outward;
a metallic shield shell that has a housing accommodation chamber that covers the housing from the outside and accommodates the housing, and physically and electrically connects a shielding material that covers the electric wire from the outside; and
a male screw member configured to screw and fix the shield shell to an attachment surface of the chassis with a screw shaft orthogonal to a fitting connection direction of the fitting portion, wherein
the shield shell includes a main wall body that covers the housing from a side opposite to the fitting portion, and a peripheral wall body that is vertically provided from a peripheral edge of the main wall body in the fitting connection direction and covers the housing from a side, and uses a space surrounded by the main wall body and the peripheral wall body as the housing accommodation chamber,
the peripheral wall body is used as a fixing wall portion for screwing and fixing a part of the peripheral wall body to the attachment surface,
the fixing wall portion includes an inner wall surface on a housing accommodation chamber side that is brought into surface contact with the attachment surface after screwing and fixing, and a screw hole for male screw member insertion in which a direction orthogonal to the fitting connection direction is a hole axis direction,
the inner wall surface of the fixing wall portion is a wall surface inclined with respect to the fitting connection direction, and is formed as an inclined surface closer to an outer wall surface side of the fixing wall portion in the fitting connection direction,
the inclination of the inner wall surface of the fixing wall portion with respect to the fitting connection direction is an inclination of a draft angle of a molding die for forming a housing accommodation chamber extracted in the fitting connection direction after formation of the housing accommodation chamber, and
the screw hole is formed in such a size that a gap is formed between an inner peripheral surface of the screw hole and the male screw member after screwing and fixing.

6. The connector according to claim 5, wherein the outer wall surface of the fixing wall portion is formed as a wall surface parallel to the inner wall surface of the fixing wall portion.

7. The connector according to claim 5, wherein
the inner peripheral surface of the screw hole includes a first inner peripheral portion formed as an inclined surface of a first truncated cone having a hole diameter increasing in the fitting connection direction on the inner wall surface side of the fixing wall portion, and a second inner peripheral portion formed as an inclined surface of a second truncated cone having a hole diameter increasing in the fitting connection direction on the outer wall surface side of the fixing wall portion, and
the second inner peripheral portion is formed to have a larger hole diameter than the first inner peripheral portion and to have a larger inclination angle with respect to the fitting connection direction than the first inner peripheral portion.

8. The connector according to claim 6, wherein
the inner peripheral surface of the screw hole includes a first inner peripheral portion formed as an inclined surface of a first truncated cone having a hole diameter increasing in the fitting connection direction on the inner wall surface side of the fixing wall portion, and a second inner peripheral portion formed as an inclined surface of a second truncated cone having a hole diameter increasing in the fitting connection direction on the outer wall surface side of the fixing wall portion, and
the second inner peripheral portion is formed to have a larger hole diameter than the first inner peripheral portion and to have a larger inclination angle with respect to the fitting connection direction than the first inner peripheral portion.
